(19) United States
(12) Patent Application Publication
(10) Pub. No.: US 2003/0002709 A1
(43) Pub. Date: Jan. 2, 2003

(54) Inspection system and method for pornographic file

(76) Inventor: Martin Wu, Taipei (TW)

Correspondence Address: RABIN & BERDO, P.C., Suite 500, 1101 14th Street, N.W., Washington, DC, 20005, US

(21) Appl. No.: 10/107,323

(22) Filed: Mar. 28, 2002

(30) Foreign Application Priority Data
Jun. 27, 2001 (TW) 90115663

(51) Int. Cl. G06K 9/00

(52) U.S. Cl. 382/100

(57) ABSTRACT

An inspection system and method for pornographic picture is to doubly filter the picture to be inspected, so as to improve the precision for discerning the pornographic picture. After the picture to be inspected is input to the inspection system for pornographic picture, the feature data of the picture to be inspected is fetched. The pornographic picture discerning engine discerns. If the pornographic picture discerning engine judges the picture to be inspected as a non-pornographic picture or the discerning ability is too low to judge, the pornographic picture discerning engine can export the picture to be inspected to a database comparing engine for inspection. The database comparing engine is connected to the pornographic picture database, use to compare the pictures of the database with the picture to be inspected. According to the feature data, the picture to be inspected is compared with the pictures of the database and a judging signal is exported.

This application incorporates by reference Taiwanese application Serial No. 90115663, filed on Jun. 27, 2001.

### BACKGROUND OF THE INVENTION

1. Field of the Invention

This invention relates to an inspection system and method for pictures. More particularly, the invention relates to an inspection system and method for pornographic pictures.

2. Description of Related Art

As the network communication and the information techniques are fast updated day by day, Internet, World Wide Web, Information High way, and so on have been developed. When all information of the data files, voice, image in our practical daily life are converted to a digital format, the information then can be transmitted to the whole world through the information network. The information can be shared by the whole world in a fillip of time. Nowadays, more and more people start to rely upon the information network to proceed for the activities of entertainment, research, and business. It has been about 400 million users on information network. The development of network has provided a fast and convenient communication environment and information circulation, and has also created a rich and secret cyberspace. Network users do not necessary to reveal their actual personal status and can freely play in it.

Recently, the network criminal events are increasing, and are concerned by people. Particularly, the pornographic criminal events through the network have been flooding over the society and harm the youths. Since the network users can easily touch the pornographic information from various pornographic web sites, including the erotic word files, pornography pictures, and motion picture. Parents always worry about their sonnies who would touch the pornographic information through the network. Those schools and public libraries, which provide users to enter the network, get the pressure requested from the parents to install software in the computer to inspect and filter the harmfild pornographic contents. Moreover, in a company, the boss of the company also complains about some employees who would download the pornographic pictures from the network or transmitting pornographic pictures through E-mail. Since most portion of the bandwidth of the network is occupied by the transmitting the pornographic pictures, company resource is spend without any profit.

The current software sold in the market for filtering the pornographic information needs a large database, which can be installed in the computer that has provides the service to entry the network. The filtering software is, for example, X-stop or SurfWatch used in the network station. When the users entry the network and try to connect a web site which is on the list of the filtering software, the connection would not be successful, such that more thousand and thousand pornographic web sites, file transfer protocol (FTP) centers, and news groups can be filtered. However, if the filtering software is not constantly updated, once the pornographic websites changes their network addresses or new web sites are made, the filtering software still cannot effectively avoid the pornographic invasion. Therefore it is needed for an inspection mechanism to instantly apply on the content of information, and directly inspect and filter out the possible pornographic picture files, so that the youths can efficiently make use of the network resources without negative effect or it can effectively prevent the company employees from occupying the network bandwidth to download the pornographic pictures.

However, the conventional method is limited by the image discerning techniques for directly inspect and filter the doubted picture files, and can be satisfied. Since the performance of the current picture discerning engine is like the ability of a ten years old child, the picture discerning engine can only roughly distinguish whether a picture is pornographic or not. A pornographic picture, which is wrongly judged as a non-pornographic picture can always pass the inspection of the picture discerning engine. On the other hand, if the data of picture is inspected and filtered by performing a comparison with the database, the picture can only be compared with known pictures stored in the database. For those pornographic pictures not stored in the database, are simply judged as non-pornographic pictures. For those new published pornographic pictures are to be wrongly judged as the non-pornographic pictures due to the information is not stored in the database.

### SUMMARY OF THE INVENTION

It is an objective of the present invention to provide an inspection system and an inspection method to effectively improve the discerning capability on the pornographic pictures.

It is another objective of the present invention to provide an inspection method to doubly filter the picture to be inspected, so as to improve the precision for discerning the pornographic picture. First, the picture to be inspected is input. The feature data of the picture to be inspected is fetched. The feature data are used to inspect the picture to be inspected. And then, according to the feature data, the picture to be inspected is compared with the picture database. Finally, the judge signal is exported.

It is another objective of the present invention to provide an inspection system for pornographic picture to doubly filter the picture to be inspected, so as to improve the precision for discerning the pornographic picture. The inspection system for pornographic picture includes a pornographic picture discerning engine, a database comparing engine, and a pornographic picture database. The pornographic picture discerning engine is used to discern the picture to be inspected and export an output selected from one of the picture to be inspected and a first judging signal. The database comparing engine is connected to the pornographic picture database used to compare the pictures of the database with the picture to be inspected, and then export a second judging signal.

It is further another objective of the present invention to provide a computer readable recording medium, used to record the method for the computer to execute the inspection of pornographic picture with doubly filtering on the picture to be inspected, so as to improve the discerning precision of the pornographic picture. The method for inspecting the pornographic picture includes first inputting the picture to be inspected. Then, the feature data of the picture to be inspected is fetched. The feature data are used to inspect the picture to be inspected. And then, according to the feature data, the picture to be inspected is compared with the picture database. Finally, the judge signal is exported.

### BRIEF DESCRIPTION OF DRAWINGS

The invention can be more fully understood by reading the following detailed description of the preferred embodiments, with reference made to the accompanying drawings, wherein:

FIG. 1 is a block diagram, schematically illustrating the inspection system for pornographic picture, according to a preferred embodiment of the invention; and

FIG. 2 is an inspection flow diagram, schematically illustrating the inspection method for pornographic picture, according to a preferred embodiment of the invention.

### DETAILED DESCRIPTION OF PREFERRED EMBODIMENTS

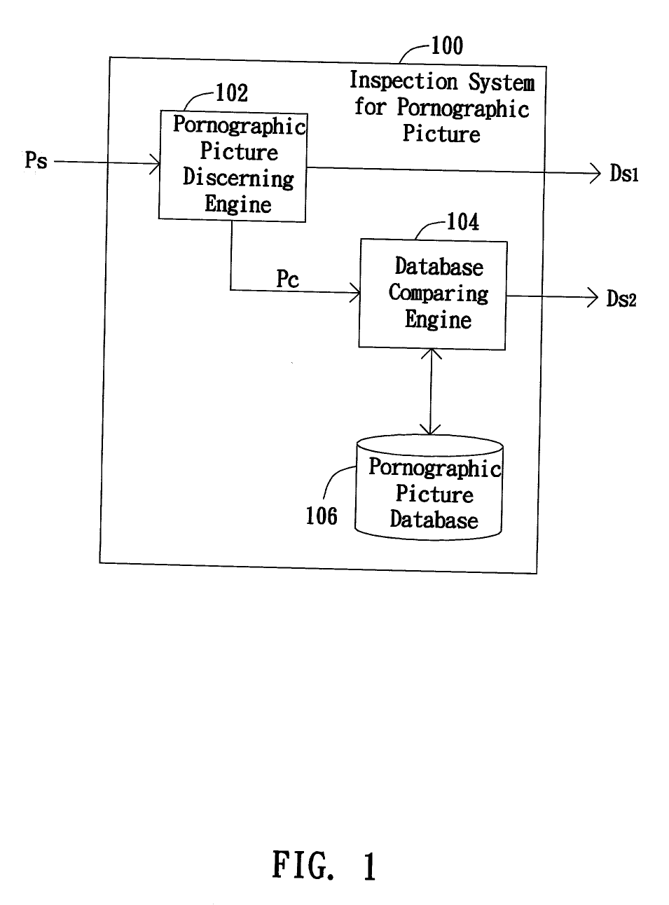

Referring to FIG. 1, FIG. 1 is a block diagram, schematically illustrating the inspection system for pornographic picture, according to a preferred embodiment of the invention. The inspection system for pornographic picture of the invention takes a pornographic picture discerning engine 102 and a database comparing engine 104 to perform double filtering, so as to improve the discerning precision for the pornographic picture. The pornographic picture discerning engine 102 is used to discern an image signal Ps of the input picture to be inspected and select one of image signal Ps of the input picture to be inspected and a first judging signal Ds1. The picture to be inspected is discerned by the pornographic picture discerning engine 102. If the pornographic picture discerning engine 102 judges the picture to be inspected as the pornographic picture, the pornographic picture discerning engine 102 exports the first judging signal Ds1. The first judging signal Ds1 includes a judging result for the picture to be inspected as the pornographic picture. If the pornographic picture discerning engine 102 judges the picture to be inspected as a non-pornographic picture or the discerning ability is too low to judge, the pornographic picture discerning engine 102 exports the picture to be inspected to the database comparing engine 104 for inspection. The database comparing engine 104 is used to compare the picture of database with the picture to be inspected, and export a second judging signal Ds2. The second judging signal includes the result for the picture to be inspected as the pornographic picture. Since the database comparing engine 104 is connected to a pornographic picture database 106, the database comparing engine 104 can search the pornographic pictures in the database 106, and perform a comparison of similarity for the pictures in the database and the picture to be inspected.

The pornographic picture discerning engine 102 uses the statistic result as the base for judging. The mathematic statistic algorithm is used to compute the feature data for the picture to be inspected, so as to obtain a feature value. At the same time, the pornographic picture discerning engine 102 is set with a pornographic feature discerning value. The sources of the feature data for picture usually includes color, style, position, size, veining distribution, object attribution, and so on. For example, since the pornographic picture usually appears in full or partial nude image, a portion ratio of skin color can be selected as one source of feature data, which is provided to the pornographic picture discerning engine 102 for judgment. The pornographic picture discerning engine 102 first defines a probability threshold for the skin color density distribution and computes a quantity of a function of a probability density by a block region of the picture. The quantity of the function of the probability density is compared with probability threshold. If the quantity of the function of the probability density is greater than probability threshold, then the color vector is judged to as belonging to skin color. Otherwise, it is not belonging to skin color. According to this, the quantity of the function of the probability density is compared with the probability threshold one by one for each of the blocks regions. As a result, each image pixels of the picture are divided into two types of skin color and non-skin color. A statistic algorithm is used to judge the portion ratio of skin color for the whole picture to serve as a feature value for this picture. In the mean time, the pornographic picture discerning engine 102, according to a relation of the feature value of the portion ratio of skin color with the set of pornographic feature discerning value, judges whether or not the picture is a pornographic picture. Since the pornographic picture discerning engine 102 directly inspects the picture to be inspected, it is not necessary to worry about that the picture to be inspected is a newly published pornographic picture. This can avoid a failure of judgment due to that the pornographic picture database 106 is not updated and the database comparing engine 104 cannot filter the pornographic picture away.

The database comparing engine 104 is connected to the pornographic picture database 106 and searches in the pornographic picture database 106. By this manner, a similarity comparison is performed between the pictures in the database with the picture to be inspected. The comparing manner used in the database comparing engine 104 takes the feature points as the base for check. The sources of feature data of picture includes color, style, position, size, veining distribution, object attribution, and so on. Therefore, it is necessary to find out the essential feature points of the pictures, which can serve as a data index. Through the comparison between the picture to be inspected and the pictures in that database, the similar pornographic picture having most features points corresponding to the picture to be inspected is found. The similarity comparison is then performed for judging the pornographic picture. The pornographic picture database 106 includes various pornographic pictures for comparison. The pornographic picture database 106 is also regularly updated. Particularly, those pornographic pictures, which are easily misjudged as a non-pornographic picture by the pornographic picture discerning engine 102 are added to the pornographic picture database so as to compensate the part which is hard to be discerned by the pornographic picture discerning engine 102. The pornographic picture is then effectively detected, resulting in the improvement of discerning ability for the pornographic picture.

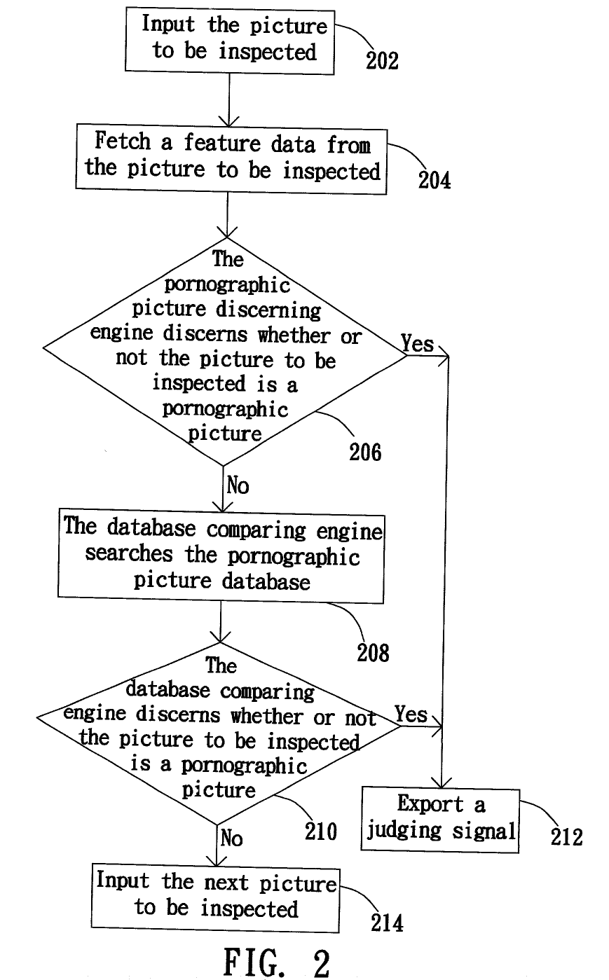

FIG. 2 is an inspection flow diagram, schematically illustrating the inspection method for pornographic picture, according to a preferred embodiment of the invention. In FIG. 1 and FIG. 2, the inspection method for the pornographic picture is taking the pornographic picture discerning engine 102 and the database comparing engine 104 to perform double filtering, so as to improve the discerning precision for the pornographic picture. In the first step 202, the picture to be inspected is inputted to the pornographic picture discerning engine 102 for the first stage of inspection. The frame is about the design of mathematic algorithm. The mathematic algorithm is designed to perform feature discerning. The pornographic picture discerning engine 102 is set with a pornographic feature discerning value. In the step 204, the inspection system for pornographic picture 100 fetches the feature data from the input picture to be inspected. The pornographic picture discerning engine 102 used the mathematic algorithm to compute out the feature value for the feature data of the picture to be inspected. Then it enters the step 206 for judgment. The pornographic picture discerning engine 102 uses the feature data to discern whether or not the picture to be inspected is a pornographic picture. When the pornographic picture discerning engine 102 judges out the pornographic picture, the method enter the step 212. The inspection system for pornographic picture 100 then exports a first judging signal Ds1. The first judging signal Ds1 includes a judging result for the picture to be inspected as the pornographic picture. When the feature value of the pornographic picture discerning engine 102 is less than the pornographic feature discerning value or the discerning ability is too low to judge, the pornographic picture discerning engine 102 exports the picture to be inspected to the database comparing engine 104 for the second stage of inspection. In the step 208, the database comparing engine 104 fetches the feature data of the picture to be inspected and compares features in the database 106. When the database comparing engine 104 finds the similar pornographic pictures corresponding to the picture to be inspected, similarity comparison is performed for judging the pornographic picture. When the picture to be inspected is judged as a pornographic picture, the process enters the step 212. The inspection system for pornographic picture 100 is then exports a second judging signal Ds2. The second judging signal includes the result for the picture to be inspected as the pornographic picture. When the database comparing engine 104 cannot find a similar pornographic picture with more corresponding feature points and the database comparing engine 104 cannot judge the picture to be inspected as a pornographic picture, the process enters the step 214. A next picture to be inspected is sent to the inspection system for pornographic picture 100 and the inspection is method for pornographic picture is repeated.

Since the database comparing engine 104 is connected to the pornographic picture database 106, the processing time is longer than that of the pornographic picture discerning engine, the first stage of inspection is set to pornographic discerning on pornographic picture in the pornographic picture discerning engine. The second stage of inspection is set to use the database comparing engine for comparison. For those pornographic picture, judged by the pornographic picture discerning engine are not necessary to be inspected in the database comparing engine 104. Considering the whole, it can reduce the time for inspection and the loading of the system.

In summary, the foregoing preferred embodiment discloses an inspection system for pornographic picture 100 and method. The pornographic picture discerning engine and the database comparing engine are used to doubly inspect. First, the picture is performed with a pornographic a discerning engine. Then, the picture which is recognized as a non-pornographic picture is compared with the database. In this manner, the picture can not only be effectively discerned for the known picture stored in the pornographic picture database, but also the newly published picture can also be discerned, so as to increase the capability for discerning pornographic picture. The solid advantages are as follows:

1. The pornographic picture discerning engine directly inspects the picture to be inspected for discerning. It is not necessary to worry about whether the picture to be inspected is the newly published pornographic picture. It can avoid the failure to filter the pornographic picture away due to the pornographic picture database is not updated.

2. The database comparing engine can compensate the part, which is hard to be discerned by the pornographic picture discerning engine, so that the pornographic picture can be effectively judged. Particularly, those pornographic pictures which are easily misjudged as a non-pornographic picture by the pornographic picture discerning engine are added to the pornographic picture database so as to improve the discerning capability of the pornographic picture.

3. The first stage of inspection is set to pornographic discerning on pornographic picture in the pornographic picture discerning engine. After filtering, the second stage of inspection is set to use the database comparing engine for comparison and check. It can reduce the time consumption and cost used in inspection, and the loading of the system.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An inspection method for pornographic picture to doubly filter a picture to be inspected, so as to increase the discerning precision, the method comprising:
(a) inputting the picture to be inspected;
(b) fetching a feature data from the picture to be inspected;
(c) discerning the picture to be inspected, according to the feature data;
(d) comparing the picture to be inspected with a database, according to the feature data; and
(e) exporting a judging signal.

2. The method of claim 1, before the step of (d) further comprising a step (d0): searching in a pornographic picture database, and performing a similarity comparison for the pornographic picture database and the picture to be inspected.

3. The method of claim 1, wherein the step of (c) using a pornographic picture discerning engine to perform discerning.

4. The method of claim 3, wherein the pornographic picture discerning engine used the statistic algorithm as a judging base.

5. The method of claim 4, wherein the pornographic picture discerning engine is set to have a pornographic feature discerning value, and in the step of (c) when the pornographic picture discerning engine computes out the feature data by computation algorithm, having a feature value less than the pornographic feature discerning value, the method enters the step of (d).

6. The method of claim 2, wherein the step of (d) uses a database comparing engine for comparing.

7. The method of claim 1, wherein the judging signal exported in the step of (e) includes a judging result for the picture to be inspected being judged as a pornographic picture.

8. An inspection system for pornographic picture to doubly filter a picture to be inspected, so as to increase the discerning precision, the system comprising:
a pornographic picture discerning engine, used to discern the picture to be inspected, and selecting an output from one of the picture to be inspected and a first judging signal; and
a database comparing engine, used to compare a picture in a database with the picture to be inspected, and then export a second judging signal.

9. The system of claim 8, wherein the database comparing engine is connected with a pornographic picture database, and the database comparing engine searches in the pornographic picture database for the picture in the database similar to the picture to be inspected.

10. The system of claim 8, wherein the pornographic picture discerning engine uses a manner of a statistic algorithm as a base.

11. The system of claim 10, wherein the picture to be inspected has a feature data.

12. The system of claim 11, wherein the pornographic picture discerning engine discerns the picture to be inspected according to feature data.

13. The system of claim 12, wherein the pornographic picture discerning engine is set with a pornographic feature discerning value.

14. The system of claim 13, wherein when the pornographic picture discerning engine computes out the feature data by computation algorithm, having a feature value greater than the pornographic feature discerning value, the pornographic picture discerning engine exports a first judging signal.

15. The system of claim 13, wherein when the pornographic picture discerning engine computes out the feature data by computation algorithm, having a feature value less than the pornographic feature discerning value, the pornographic picture discerning engine exports the picture to be inspected to the database comparing engine.

16. The system of claim 11, wherein the database comparing engine performs comparison between picture to be inspected and the picture of the database, according to the feature data.

17. The system of claim 8, wherein the first judging signal includes a result for judging the picture to be inspected as the pornographic picture.

18. The system of claim 8, wherein the second judging signal includes a result for judging the picture to be inspected as the, pornographic picture.

19. A computer readable recording medium, used to record for allowing a computer to execute an inspection method for pornographic picture and doubly filter on a picture to be inspected, so as to increase the discerning precision of the pornographic picture, the method comprising:
(a) inputting the picture to be inspected;
(b) fetching a feature data from the picture to be inspected;
(c) discerning the picture to be inspected, according to the feature data;
(d) comparing the picture to be inspected with a picture of a database, according to the feature data; and
(f) exporting a judging signal.

20. The computer readable recording medium of claim 19, before the step of (d) further comprising a step (d0): searching in a pornographic picture database, and performing a similarity comparison for the pornographic picture database and the picture to be inspected.

21. The computer readable recording medium of claim 19, wherein the step of (c) using a pornographic picture discerning engine to perform discerning.

22. The computer readable recording medium of claim 19, wherein the pornographic picture discerning engine used the statistic algorithm as a judging base.

23. The computer readable recording medium of claim 21, wherein the pornographic picture discerning engine is set to have a pornographic feature discerning value, and in the step of (c) when the pornographic picture discerning engine computes out the feature data by computation algorithm, having a feature value less than the pornographic feature discerning value, the method enters the step of (d).

24. The computer readable recording medium of claim 19, wherein the step of (d) uses a database comparing engine for comparing.

25. The computer readable recording medium of claim 19, wherein the judging signal exported in the step of (e) includes a judging result for the picture to be inspected being judged as a pornographic picture.
